(19) United States
(12) Patent Application Publication
(10) Pub. No.: US 2014/0095218 A1
(43) Pub. Date: Apr. 3, 2014

(54) VIRTUAL GIFT CARD GIFTING OR SHARING

(71) Applicant: Gregg J. Golembeski, San Francisco, CA (US)

(72) Inventor: Gregg J. Golembeski, San Francisco, CA (US)

(21) Appl. No.: 13/631,487

(22) Filed: Sep. 28, 2012

(51) Int. Cl. G06Q 30/06; G07B 15/02; G06Q 10/02

(52) U.S. Cl. 705/5; 705/26.1; 705/13

(57) ABSTRACT

Improved techniques and systems to facilitate gifting using items representative of credit, value and/or event admission in a client-server environment are disclosed. A networked device, such as a wireless electronic device, can act as a client. The client can be networked to a server for obtaining, virtualizing, storing, and/or accessing such items. Further, the client-server environment can provide for a user sharing and/or gifting such items with other users.

### CROSS-REFERENCE TO OTHER APPLICATION

This application claims priority to U.S. Provisional Patent Application No. 61/657,836 filed Jun. 10, 2012, entitled “VIRTUAL GIFT CARD GIFTING OR SHARING,” which is herein incorporated by reference

### BACKGROUND OF THE INVENTION

Today, an online media store, such as the iTunes Store® offered by Apple Inc., allows music to be purchased using prepayments associated with music cards (i.e., gift cards). A recipient of a music card can redeem the music card for its credit value based on its face value denomination, such as $15, $25, $30 and $50, at the iTunes Store®. These music cards can be purchased at retailers as is commonly done with gift cards.

Using a wireless electronic device, such as an iPhone®, a user can access the iTunes Store® to redeem the music card. Once the music card has been redeemed, the associated dollar amount is credited. Each time music is purchased from the iTunes Store®, music files or other media files may be downloaded to the wireless electronic device, and the iTunes Store® reduces the user's credit.

Once the music card has been redeemed, the user can advantageously and conveniently manage the user's credit using the iTunes Store®. Once the music card is redeemed, the user no longer needs to be concerned about losing or misplacing the music card, because the user's credit is safe and managed. Moreover, it can be accessed conveniently and wirelessly from anywhere using the iPhone®. Unfortunately, other items that users may carry around in their wallets such as other gift cards, coupons or entertainment or transportation event tickets may be lost or misplaced, without the availability of the benefits of a convenient management system as can be had with music cards using the iTunes Store® and iPhone® access.

Accordingly, while music cards and credit management by the iTunes Store® and iPhone® access may provide many benefits, some other challenges may still remain since the benefits may not be available for other items that users may carry around in their wallets, such as other gift cards, coupons or entertainment or transportation event tickets. Further, although a user may receive, for example, a gift of a music card and the associated benefits of credit and media files, the user may not have an easy way in turn to share, gift or otherwise provide such benefits to others. Thus, there is a need for improved approaches to gifting using items representative of credit, value and/or event admission.

### SUMMARY

The invention relates to improved techniques and systems to facilitate virtual gifting using items representative of credit, value and/or event admission in a client-server environment. A user can acquire or gift such items, such as gift cards, coupons or entertainment or transportation event tickets in a variety of different ways. A networked device, such as a wireless electronic device, can act as a client. The client can be networked to a server for obtaining, virtualizing, storing, and/or accessing such items.

The invention can be implemented in numerous ways, including as a method, system, device, apparatus, or computer readable medium. Several embodiments of the invention are discussed below.

In one embodiment, a computer implemented method for sharing at least a portion of a gift card having a known value includes: receiving gift card credit information from a first user; receiving a gift request from the first user to share at least a portion of the gift card with a second user, the gift request identifying a particular physical redeemable gift that can be acquired by the second user or a monetary gift amount that is less than the known value; electronically providing a redeemable electronic gift receipt to the second user, the redeemable electronic gift receipt being representative of the gift request and enabling the second user to physically acquire the particular physical redeemable gift.

In another embodiment, a computer implemented gifting method for acquiring an item or an admission to an event using a gift credit includes at least: providing, at a remote server, a credit code of a giftor, the gift credit being associated with the credit code; receiving, at the remote server, a gifting authorization from a first electronic device to allow access to the credit code by a giftee, the gifting authorization including a validation request; validating a validation request from or for a second electronic device; permitting access to the credit code by the giftee if the validation request is valid; and thereafter receiving credit redemption notification at the remote server indicating consumption of the gift credit associated with the credit code to reduce or eliminate a purchase cost of the item or the admission to the event purchased or acquired by the giftee.

In still another embodiment, a computer implemented gifting method for acquiring an item or an admission to an event using a gift credit the invention includes at least: providing, at a remote server, a credit code of a giftor, wherein the gift credit is associated with the credit code; receiving, at the remote server, a gifting authorization from a first electronic device to allow access to the credit code by a giftee; and transmitting a gift notification from the remote server to a second electronic device.

In yet another embodiment, a computer implemented gifting method for acquiring an item or an admission to an event using a gift credit the invention includes at least: providing at a remote server a credit code of a giftor, wherein the gift credit is associated with the credit code; receiving, at the remote server, a gifting authorization from a first electronic device to allow access to the credit code by a giftee; thereafter receiving credit redemption notification at the remote server indicating consumption of the gift credit associated with the credit code to reduce or eliminate a purchase cost of the item or the admission to the event purchased or acquired by the giftee.

Other aspects and advantages of the invention will become apparent from the following detailed description taken in conjunction with the accompanying drawings.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a gifting system according to one embodiment.

FIGS. 2A-2G are block diagrams illustrating an example operation of the gifting system shown in FIG. 1.

FIG. 3 is a flow diagram of a process for sharing at least a portion of a gift card according to one embodiment.

FIG. 4 is a flow diagram of a process for acquiring an item or an admission to an event using a gift credit according to one embodiment.

FIG. 5 is a flow diagram of another process for acquiring an item or an admission to an event using a gift credit according to another embodiment.

FIG. 6 is a flow diagram of yet another process for acquiring an item or an admission to an event using a gift credit according to another embodiment.

### DETAILED DESCRIPTION OF EMBODIMENTS OF THE INVENTION

The invention relates to improved techniques and systems to facilitate virtual gifting using items representative of credit, value and/or event admission in a client-server environment. A user can acquire or gift such items, such as gift cards, coupons or entertainment or transportation event tickets in a variety of different ways. A networked device, such as a wireless electronic device, can act as a client. The client can be networked to a server for obtaining, virtualizing, storing, and/or accessing such items.

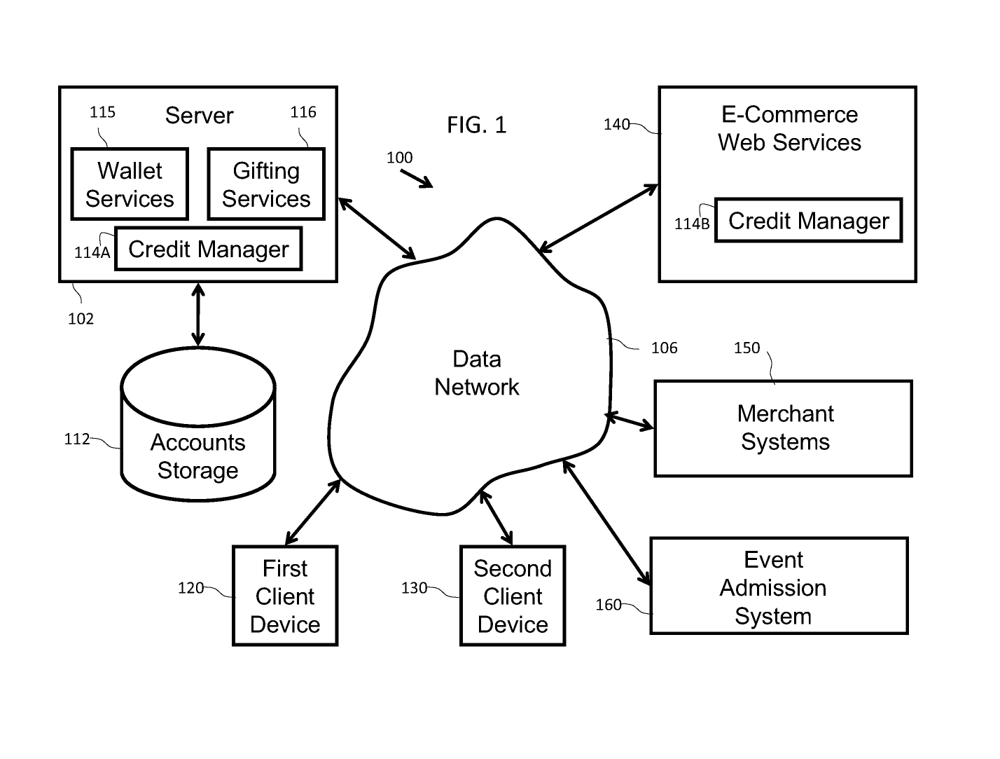

Embodiments of the invention are discussed below with reference to FIGS. 1-6. However, those skilled in the art will readily appreciate that the detailed description given herein with respect to these figures is for explanatory purposes as the invention extends beyond these limited embodiments.

FIG. 1 is a block diagram of a gifting system 100 according to one embodiment. The gifting system 100 may include a remote server 102. The remote server 102 can coordinate obtaining, virtualizing, storing, and/or accessing items representative of credit, value and/or event admission using wallet services 115. As will be discussed in greater detail below, the remote server 102 can (i) coordinate sharing and/or gifting of such items with other users via gifting services 116; (ii) facilitate and manage data via wallet services 115; and (iii) store data in accounts storage 112. It should be recognized that although not depicted in FIG. 1, the remote server 102 can include other components, blocks and functionality as is typically provided by a remote server such as a memory, processor, and other hardware and software to perform other functions.

Further, as shown in FIG. 1, first and second client devices 120, 130 may be configured to communicate with the remote server 102 via a data network 106. In one embodiment, the data network 106 comprises at least a portion of the Internet. Typically, the gifting system 100 may have a plurality of different client devices 120, 130. Each client may include a respective computer running software for interacting over data network 106 with software modules running on remote server 102 for credit manager 114A, wallet services 115, and gifting services 116. The first and second client devices 120, 130 can vary with application but generally are computing devices that have memory storage. Often, the first and second clients 120, 130 are personal computers or other computing devices (e.g., personal digital assistant (PDA), portable media player, mobile telephone) that may be capable of storing and presenting digital media to their users.

The wallet services 115 may be configured to receive credit information (e.g., gift card credit information, music card information, coupon information, transportation ticket information, entertainment ticket information, and the like) from a client device 120, 130. The credit information may include a unique credit code. For example, the unique credit code may be credit information associated with a gift card, coupon, or entertainment or transportation ticket of the first user. More generally, the unique credit code may be credit information associated with other items representative of credit, value and/or event admission of the first user.

To provide for virtualization of one or more of the items representative of credit, value and/or event admission, the credit information may be captured in a variety of ways. In one embodiment the unique credit code can be entered manually using the first client device 120. In another embodiment, a camera of the first client device 120 may capture and recognize characters of the credit code displayed on the item. The credit code may be displayed as text, graphics, a one or two-dimensional bar code, or any other indicia displayed on the item.

The credit information may be stored in the accounts storage 112. The credit information may be stored in one or more credit entries in an account associated with the user, such as the first user. Accounts storage 112 may also be configured to store user access information such as user names, passwords, validation credentials, and the like.

As such, wallet services 115 may be configured to control access to user accounts stored in accounts storage 112. In one embodiment, wallet services 115 may be configured to request user access information from client device 120, 130 to create and associate a user account stored in accounts storage 112. The user access information may be obtained from client devices 120, 130 from any known means such as manual input.

In another embodiment, wallet services 115 may be configured to authenticate and/or verify the user associated with the user account. The user may be authenticated and/or verified via any known means such as validating credentials, passwords, user name, user information, and the like. For example, the wallet services 115 of the remote server 102 may receive an account access validation request to access an account of the first user. Wallet services 115 may validate the account access validation request by matching the user name and password with the user name and password stored in the account storage 112. If the user name and password match, wallet services 115 may grant access to the account associated with the first user.

Gifting services 116 may be configured to coordinate sharing and/or gifting of items representative of credit, value and/or event admission. For example, the first user may be a giftor and the second user may be a giftee. First user may submit a gift request to the remote server 102 to share at least a portion of the first user's gift card with the second user. More particularly, the gifting services 116 of the remote server 102 may receive a gift request authorization via the data network 106 from the first user of the first client device 120. To provide for such gifting, the gifting services 116 of the remote server 102 may electronically provide a redeemable electronic gift receipt to the second user. More particularly, the gifting services 116 of the remote server 102 may transmit the redeemable electronic gift receipt via the data network 106 to the second user of the second client device 130. The redeemable electronic gift receipt may include a unique credit code that is stored in accounts storage 112.

Credit manager 114A may be configured to coordinate and enable the redemption, management, and utilization of credit. For example, credit manager 114A may coordinate and enable the redemption, management, and utilization of credit for a redeemable gift gifted to or shared with a second user. In one embodiment, digital media assets can be acquired using the remote server 102. Typically, the digital media assets would be purchased for a cost. However, when the user has available credit (e.g., gifted credit), the purchase can be through use of the available credit. The credit manager 114A may be configured to maintain credit amounts for users, determine when credit can be used, and can apply credit as appropriate. The media credit manager 114A may have functional blocks, software modules, and/or data structures associated with credit redemption, credit management, and credit utilization. The credit manager can manage the credit for acquired or shared redeemable gifts. In doing so, the credit manager can interact with credit redemption data, user account data and credit authorization data.

Credit redemption data may be data used to validate one or more credit redemption requests. The one or more credit redemption requests may be to redeem redeemable electronic gift receipts. For example, a credit redemption notification may have a credit redemption request for redemption of the redeemable electronic gift receipt. The credit redemption notification may include a credit code of the redeemable electronic gift receipt, for example, as may be provided by, or as may be derived from the redeemable electronic gift receipt. The credit redemption notification may include a validation request for validating the credit code of the redeemable electronic gift receipt.

In one embodiment, the credit manager 114A of the remote server 102 may receive the credit redemption notification (and more particularly may receive the credit redemption request, the credit code of the redeemable electronic gift receipt, and/or the validation request) via the data network 106 from the second user of the second client device 130. The credit manager 114A may use the credit redemption data to validate the credit redemption request for redemption of redeemable electronic gift receipts. In particular, the credit manager 114A of the remote server 102 may use the credit redemption data to validate the credit code of the redeemable electronic gift receipt in response to the validation request.

It should be understood that the credit manager 114A can validate the credit code using the credit redemption data. If the credit code is determined to be valid, the credit manager can allocate the credit associated therewith to a credit amount for the second user. Subsequently, if the second user requests to purchase one or more items (e.g. digital media items) from the online store (e.g. the online media store), such as may be hosted by the remote server 102, the credit manager 114A can determine whether the one or more items to be purchased can be provided to the user at no cost or a reduced cost by the application of some or all of the credit amount associated with the second user. In such cases, the credit manager 114A can determine whether the one or more items that are to be purchased are authorized for credit utilization. In this case, the credit manager can consult the credit authorization data. When the credit authorization data indicates that the one or more items are available for credit utilization (for example, by determining whether there is a sufficient match between the items or item related data and the credit authorization data), then the purchase cost for the one or more items can be reduced or eliminated by the application of the credit amounts associated with the second user.

For example, if the user requests to purchase two items that both qualify for credit utilization, then the credit amount, which may be gifted credit, associated with the user would be reduced by two units. Typically, the purchase cost would then be eliminated and thus the user would have acquired the two items using only accrued gift credit. However, it should be noted that the gift credit amounts can be limited to a particular price, price range, item, item type, or any other criteria as may be specified in the credit utilization data.

For the sake of simplicity of illustration, e-commerce web services 140 (which may include its own credit manager 1148) and merchant systems 150 are shown in FIG. 1 as separate from remote server 102. Remote server 102 may coordinate with the second client device 130 to access via the data network 106 various merchant systems 150 and e-commerce web services 140 as software modules running on other servers. However, although shown as separate in FIG. 1, it should be understood that in various embodiments one or more e-commerce web services 140 and merchant systems 150 software modules or portions thereof may run on the remote server 102. For example, in embodiments providing an online store (e.g. an online media store, such as the iTunes Store®), one or more e-commerce web services 140 and merchant systems 150 software modules or portions thereof may run on the remote server 102.

For interactions with media items and the online media store, such as in the example illustrated above, the second client device 130 may include a digital media player. The digital media player can be an application program (e.g., specific software application or web browser program) that operates on the second client device 130. One popular example of a digital media player is the iTunes® client software. The second client device 130 can interact with the remote server 102 to review and/or acquire media items. For example, one or more of the merchant systems 150 may provide mass storage of the numerous digital media items that may be accessible via the gifting system 100. The digital media items can be accessed from a digital media store of one or more of the merchant systems 150 over the data network 106 by way of the remote server 102.

More particularly, the gifting system 100 allows the second user of the second client device 130 to utilize the digital media player to browse, search or sort through a plurality of digital media items that can be accessed (e.g., for purchase, review, preview, and the like) using the remote server 102. The digital media player of the second client device 130 may also allow the second user to preview a digital media item of the digital media items. In the event that the second user of the second client device 130 desires to purchase a particular media item, the second user (via the second client device 130) and the remote server 102 may engage in an on-line commerce transaction in which the second user purchases access rights to the particular digital media item.

After purchase of a particular digital media item, the remote server 102 can send download information to the digital media player of the second client device 130. The download information can then be used by the digital media player (and the second client device 130) to retrieve the digital media content for the particular digital media item by interacting with the remote server 102 through the data network 106. In this regard, the remote server 102 coordinates obtaining the digital media content corresponding to the particular digital media item and downloads such content through the data network 106 to the second client device 130. The downloaded digital media content can then be stored on the second client device 130.

In one embodiment, the remote server 102 can act as a single server to retrieve the digital media content. However, in another embodiment, digital media content may be retrieved using multiple servers. For example, a search request may be transmitted to the remote server 102 to perform a search in accordance with at least one search criteria for a particular song or album. The search criteria may be a song name, album name, artist name, or any other search criteria information. The remote server 102 may include at least information (e.g., metadata) for a large number of digital media items that are available to be purchased using the remote server 102. In another embodiment, one or more other servers may include the information (e.g., metadata) for a large number of digital media items that are available to be purchased using the remote server 102.

Using the second client device 130, the second user may use the remote server 102 to access the online music store, so as to redeem the redeemable electronic gift receipt. Once the redeemable electronic gift receipt has been redeemed, the dollar amount associated with the redeemable electronic gift receipt is credited to the user using the credit manager 114A. In other words, the dollar amount associated with the redeemable electronic gift receipt is credited to the user using the credit manager 114A and stored in the account associated with the user in the accounts storage 112. Each time music is purchased from the online music store, music files or other media files may be downloaded to the second client device 130, and the online music store can update and/or reduce the second user's credit using the credit manager 114A.

Although the gifting system 100 is discussed as utilizing an online media store, it should be understood that the gifting system 100 is not limited to the online media store or to acquiring media items using gift media item credit. Gifting system 100 may use remote server 102 to coordinate with merchant systems 150 for e-commerce transactions to acquire other items and/or event admissions using gift credit and/or other items of value such as money.

For example, a particular physical redeemable gift (e.g. electronics, books, house wares, and the like) may be acquired using the gifting system 100. The gift request authorization may include credit authorization data identifying the particular physical redeemable gift. The redeemable electronic gift receipt may be representative of the gift request and may enable the second user to physically acquire the particular physical redeemable gift.

In one embodiment, the gift request authorization submitted by the first user to share at least a portion of a known value of the gift card with the second user may include credit authorization data. The credit authorization data may limit the gift credit for the second user to one or more of a particular price, price range, item, item type, and any other criteria. For example, the gift request authorization submitted by the first user may include credit authorization data that limits gift credit for the second user by identifying a particular physical redeemable gift that can be acquired by the second user. In another example, the gift request authorization submitted by the first user may include credit authorization data that limits gift credit for the second user by a monetary gift amount that is less than the known value of the first user's gift card.

If the second user requests to purchase a particular physical redeemable gift, the credit manager 114A can determine whether the particular physical redeemable gift to be purchased can be provided to the user at no cost or a reduced cost by the application of some or all of the credit amount associated with the second user. In such cases, the credit manager 114A can determine whether the particular physical redeemable gift requested for purchase by the second user is authorized for credit utilization. In this case, the credit manager 114A can consult the credit authorization data. When the credit authorization data indicates that the particular physical redeemable gift is available for credit utilization, then the purchase cost for the particular physical redeemable gift can be reduced or eliminated by the application of the gift credit or gift credit amounts associated with the second user.

In the case of the online store, once the particular physical redeemable gift is purchased, the online store can ship the particular physical redeemable gift to a convenient location as may be specified by the second user, so as to provide for the second user physically acquiring possession of the particular physical redeemable gift.

As another example, instead of acquiring items using the online store, the merchant systems 150 may include a manned or unmanned computerized point of sale kiosk. In such case, the second user and the second client device 130 may be located proximate to the point of sale kiosk of the merchant systems 150, so as to provide for the second user physically acquiring possession of the particular physical redeemable gift upon completion of purchasing using the point of sale kiosk.

In use, when the second user is proximate the sale kiosk, the second user may use the second client device 130 to display or otherwise transmit to the point of sale kiosk at least a portion of the redeemable electronic gift receipt. For example, the second user may display the unique credit code of the redeemable electronic gift receipt on a display of the second client device 130. If the point of sale kiosk of the merchant systems 150 is manned by an operator, then the credit code can be read by the operator from the display of the second client device 130 and entered manually by the operator using the point of sale kiosk. In another embodiment, a camera of the point of sale kiosk may capture and recognize characters of the credit code displayed by the second client device 130. The credit code may be displayed as text, graphics, images, a one or two-dimensional bar code, or any other indicia to display a credit code. In yet another embodiment, the second client device 130 and the point of sale kiosk may communicate the credit code through the data network 106. Alternatively or additionally, the second client device 130 and the point of sale kiosk may communicate the credit code through near field communications. More generally, the second client device 130 and the point of sale kiosk may communicate the credit code through short-range wireless communications. Short-range wireless communications may comprise near field communications and/or Bluetooth communications and/or Bluetooth LE communications.

In any case, the redeemable electronic gift receipt, or more particularly the credit code of the redeemable electronic gift receipt, may be submitted to the point of sale kiosk, which may enable the second user to purchase and to physically acquire the particular physical redeemable gift at the point of sale kiosk.

In one embodiment, if the point of sale kiosk of the merchant systems 150 is manned by an operator, then item data related to a particular physical redeemable gift may be entered manually by the operator using the point of sale kiosk. Alternatively or additionally, the point of sale kiosk may capture some item data of the particular physical redeemable gift via any known method (e.g., UPC code data from an RFID tag on the particular physical redeemable gift, a one or two-dimensional bar code that may be displayed by the physical redeemable gift, and any other similar methods to associate item data with a product). The point of sale kiosk may use the item data to query a product database (e.g., stored at merchant systems 150 or E-commerce web services 140) to obtain additional item data such as purchase cost and data descriptive of the particular physical redeemable gift.

When using a point of sale kiosk, the credit manager 114A of the remote server 102 may receive a credit redemption notification (which may include a credit redemption request, credit code of the redeemable electronic gift receipt, and/or a validation request) via the data network 106 from the point of sale kiosk of the merchant systems. The credit redemption notification may include the item data related to the particular physical redeemable gift. The credit manager 114A of the remote server 102 may use the credit redemption data to validate the credit code of the redeemable electronic gift receipt in response to the validation request. If the credit code is determined to be valid, the credit manager 114A can deduct the credit amount associated with the second user and allocate the credit associated therewith to a credit amount for the purchase of the particular physical redeemable gift by the second user at the point of sale kiosk.

Accordingly, when the second user requests the particular physical redeemable gift at the point of sale kiosk, the kiosk may transmit the credit redemption notification to the credit manager 114A. The credit manager 114A may then determine whether the particular physical redeemable gift to be purchased can be approved for purchase and provided to the user at no cost or a reduced cost by the application of some or all of the credit amount associated with the second user. In such cases, the credit manager 114A can determine whether the particular physical redeemable gift to be purchased is authorized for credit utilization.

In this case, the credit manager may consult the credit authorization data and/or the item data. For example, the credit manager 114A may compare the item data and the credit authorization data. When comparison of the item data and the credit authorization data indicates that the particular physical redeemable gift is available for credit utilization, the purchase cost for particular physical redeemable gift can be reduced or eliminated by the application of the gift credit or gift credit amounts associated with the second user. Gift credits or gift credit amounts can be limited to a particular price, price range, item, item type, etc. as may be specified in the credit utilization data.

When the credit manager 114A of the remote server 102 approves the credit redemption notification for purchase of the particular physical redeemable gift, the credit manager 114A of the remote server 102 can coordinate effecting payment (and can coordinate recognition of payment at the point of sale kiosk). Payment may be coordinated by employing the e-commerce web services 140, and more particularly by employing suitable data messaging via the data network 106 among the remote server 102, the e-commerce web services 140 and the point of sale kiosk of the merchant systems 150. Once the point of sale kiosk recognizes payment, the second user may acquire possession of the particular physical redeemable gift. Furthermore, after the credit manager 114A of the remote server 102 approves the credit redemption notification for purchase of the particular physical redeemable gift, the credit manager 114A of the remote server 102 can update and/or reduce the second user's credit.

Although illustrated using the credit manager 114A of the remote server 102 to effect payment, in another embodiment, credit manager 1148 of the e-commerce web services 140 may also effect payment. Credit manager 1148 may receive an independent credit redemption notification via the data network 106 from the point of sale kiosk of the merchant systems 150. Such credit manager 1148 may be operated by gift-card service providers such as FIRST DATA® or COMDATA® or the like. In such case, the credit manager 1148 of the gift card service provider can validate the credit code of the independent credit redemption notification, and can coordinate effecting payment (and can coordinate recognition of payment at the point of sale kiosk) by employing suitable data messaging via the data network 106.

In still another embodiment, the second user of the second client device 130 may transmit a first credit redemption notification to the credit manager 114A of the remote server 102, when the second user is ready to purchase the particular physical redeemable gift at the point of sale kiosk. In other words, aside from the independent credit redemption notification received by the credit manager 1148 of the gift card service provider, the credit manager 114A of the remote server 102 may receive a first credit redemption notification from the second user, using the second client device 130 via the data network 102. The first credit redemption notification from the second user may include the credit code of the redeemable electronic gift receipt. The credit manager 114A of the remote server 102 may analyze the credit code, and may recognize from the credit code that validation of the credit code is to be performed by the credit manager 1148 of the gift card service provider. Further, from analyzing the credit code, the credit manager 114A of the remote server 102 may determine and/or recognize that effecting payment (and coordinating recognition of payment at the point of sale kiosk) is to be performed by the credit manager 1148 of the gift card service provider.

Accordingly, the credit manager 114A of the remote server 102 may then use the credit code to request a second credit redemption notification from the e-commerce web service 140 (e.g., the gift card service provider) in response to receiving the first credit redemption notification from the second user using the second client device 130 via the data network 102. The credit manager 114A of the remote server 102 may then receive the second credit redemption notification from the e-commerce web service in response to the request by the remote server. The second credit redemption notification from the e-commerce web services 140 may include item data. In particular, the second credit redemption notification from the e-commerce web service 140 may include purchase data related to purchase of the particular physical redeemable gift at the point of sale kiosk, for example, purchase cost of the particular physical redeemable gift, time of credit redemption, location of credit redemption, or any other similar purchase data. Using item data and/or purchase data in the second credit redemption notification from the e-commerce web services 140, the credit manager 114A of the remote server 102 can update and/or reduce the second user's credit. For example, using the purchase cost of the particular physical redeemable gift, the credit manager 114A of the remote server 102 can update and/or reduce the second user's credit by an amount corresponding to the purchase cost of the particular physical redeemable gift.

Accordingly, it should be understood that the first credit redemption notification may include notification of at least one of: a first notification of time of credit redemption and a first notification of location of credit redemption. The credit manager 114A of the remote server 102 may request a second credit redemption notification from the e-commerce web services 140. The credit manager 114A of the remote server 102 may receive the second credit redemption notification from the e-commerce web services 140 in response to the request by credit manager 114A of the remote server 102. The second credit redemption notification may include at least one of: a second notification of time of credit redemption and a second notification of location of credit redemption.

The second credit redemption notification from the e-commerce web services 140 may also include additional data related to or associated with numerous purchases using the first user's credit code, in addition to the second user's authorized use of the first user's credit code for purchase of the particular physical redeemable gift. For example, e-commerce web services 140 (e.g., gift-card service providers such as FIRST DATA®, COMDATA®, or other similar service providers) may broadly report numerous purchases using the first user's credit code, in addition to the second user's authorized use of the first user's credit code for purchase of the particular physical redeemable gift. The credit manager 114A of the remote server 102 may compare and/or correlate data of the first credit redemption notification with data of the second credit redemption notification, so as to identify and/or isolate data in the second credit redemption notification that is related to the second user's purchase and/or acquiring of the particular physical redeemable gift.

In particular, the credit manager 114A of the remote server 102 may compare and/or correlate at least one of: the first notification of time of credit redemption with the second notification of time of credit redemption and the first notification of location of credit redemption with the second notification of location of credit redemption. The credit manager 114A of the remote server 102 may isolate and/or identify data in the second credit redemption notification that is related to the second user's purchase and/or acquiring of the particular physical redeemable gift, based on correlation of at least one of: the first notification of time of credit redemption with the second notification of time of credit redemption, and the first notification of location of credit redemption with the second notification of location of credit redemption.

Using data in the second credit redemption notification that the credit manager 114A of the remote server 102 isolates and/or identifies as being related to the second user's purchase and/or acquiring of the particular physical redeemable gift, the credit manager 114A of the remote server 102 can update and/or reduce the second user's credit. For example, when the credit manager 114A of the remote server 102 isolates and/or identifies the purchase cost of the particular physical redeemable gift, the credit manager 114A of the remote server 102 can update and/or reduce the second user's credit by an amount corresponding to the purchase cost of the particular physical redeemable gift. As another example, when the credit manager 114A of the remote server isolates and/or identifies descriptive information of the particular physical redeemable gift, the credit manager 114A of the remote server 102 can notify first user of descriptive information of the particular physical redeemable gift.

As mentioned previously, the gifting system 100 may provide for the gifting of tickets such as, for example, entertainment or travel tickets. A second user of the second client device 130 may acquire the tickets using gift credit obtained from a first user. The tickets may be, for example, a transportation ticket used for a train, subway, bus, automobile, boat, airplane, or any other transportation device. In another embodiment, the tickets may be to acquire admission to an entertainment event, such as a sporting event, music concert, movie showing, or the like.

The remote server 102 of the gifting system may be configured to communicate with an event admission system 160 via the data network 106 to purchase or acquire the tickets. The event admission system 160 may be a web-based service, a computerized kiosk, a point of sale location, or any other facility to obtain or purchase tickets.

When purchasing the event admission ticket using the gifting system 100 shown in FIG. 1, the second user may use the second client device 130 to display or otherwise transmit to the kiosk at least a portion of the redeemable electronic gift receipt, such as, the unique credit code of the redeemable electronic gift receipt. The unique credit code of the redeemable electronic gift receipt may be displayed as text, graphics, a one or two-dimensional bar code, or any other similar indicia. For example, if the kiosk of the event admission system 160 is manned by an operator, the credit code can be read by the operator from the display of the second client device 130 and entered manually by the operator using the computerized kiosk. In another embodiment, a camera of the kiosk may capture and recognize characters of the credit code presented on a display of the second client device 130. In yet another embodiment, the second client device 130 and the computerized kiosk may communicate the credit code through the data network 106. Alternatively or additionally, the second client device 130 and the kiosk may communicate the credit code through near field communications. More generally, the second client device 130 and the kiosk may communicate the credit code through short-range wireless communications. Short-range wireless communications may comprise near field communications and/or Bluetooth communications and/or Bluetooth LE communications.

In any case, the redeemable electronic gift receipt, or more particularly the credit code of the redeemable electronic gift receipt, may be submitted to the kiosk, which may enable the second user to purchase and/or acquire the ticket at the kiosk.

In one embodiment, the kiosk may use the event admission data to query a database (e.g., a database of the event admission system) to obtain additional event admission data, which may include purchase cost and/or data descriptive of the event admission. The event admission data may include the title of the show, movie name, date of event, time of event, artist names, and any other data pertaining to the event.

The credit manager 114A of the remote server 102 may receive a credit redemption notification (and more particularly may receive credit redemption request, credit code of the redeemable electronic gift receipt, and/or validation request) via the data network 106 from the kiosk of the event admission system 160. The credit redemption notification may include event admission data related to the event. The credit manager 114A of the remote server 102 may use the credit event admission data to validate the credit code of the redeemable electronic gift receipt in response to the validation request. If the credit code is determined to be valid, the credit manager 114A can allocate the credit associated therewith to a credit amount for the purchase of the event admission by the second user at the point of admission kiosk.

Accordingly, when the second user requests the event admission at kiosk, the credit redemption notification may be transmitted to the remote server 102. The credit manager 114A of the remote server 102 can then determine whether the event admission or ticket to be purchased can be approved for purchase and provided to the user at no cost or a reduced cost by application of some or all of the credit amount associated with the second user. In such cases, the credit manager 114A can determine whether the event admission to be purchased is authorized for credit utilization.

The credit manager may consult the credit authorization data and/or the event admission data. For example, the credit manager 114A may compare the event admission data and the credit authorization data. When comparison of the event admission data and the credit authorization data indicates that the event admission is available for credit utilization, then the purchase cost for event admission can be reduced or eliminated by the application of a credit amount associated with the second user. The credits or gift credits can be limited to a particular event admission price, event admission price range, event, event type, or the like as may be specified in the credit utilization data.

When the credit manager 114A of the remote server 102 approves the credit redemption notification for purchase of the event admission or ticket, the credit manager 114A of the remote server 102 can coordinate effecting payment (and can coordinate recognition of payment at the point of admission kiosk) of the ticket. The credit manager 114A may utilize the data network 106, e-commerce web services 140, and the kiosk of the event admission system 160 to effectuate payment. Once the kiosk recognizes the payment for event admission, the second user may acquire event admission (e.g. be admitted to the event, issued a ticket, or the like). Furthermore, after the credit manager 114A of the remote server 102 approves the credit redemption notification for purchase of the event admission, the credit manager 114A of the remote server 102 can update and/or reduce the second user's credit.

In the example discussed above, the credit manager 114A of the remote server 102 can receive the credit redemption notification from the kiosk of the event admission system 160. However, in another embodiment, credit manager 1148 of the e-commerce web services 140 may receive an independent credit redemption notification via the data network 106 from the kiosk of the event admission system 160. The credit manager 1148 may be operated by gift-card service providers such as FIRST DATA® or COMDATA® or other similar service providers. The credit manager 1148 of the gift card service provider can validate the credit code of the independent credit redemption notification, and can coordinate effecting payment (and can coordinate recognition of payment at the point of admission kiosk) by employing suitable data messaging via the data network 106.

In use, the second user of the second client device 130 may transmit a first credit redemption notification to the credit manager 114A of the remote server 102, using the second client device 130 via the data network 102. The first credit redemption notification from the second user may include at least the credit code of the redeemable electronic gift receipt. The credit manager 114A of the remote server 102 may analyze the credit code, and may recognize from the credit code that validation of the credit code is to be performed by the credit manager 1148 of the gift card service provider or the credit manager 1148. Additionally, from the analyzing the credit code, the credit manager 114A of the remote server 102 may recognize that effecting payment (and coordinating recognition of payment at the kiosk) may be performed by the credit manager 1148 of the gift card service provider.

Accordingly, the credit manager 114A of the remote server 102 may then use the credit code to request a second credit redemption notification from the e-commerce web service 140 (e.g., gift card service provider) in response to receiving the first credit redemption notification from the second user using the second client device 130 via the data network 102. The credit manager 114A of the remote server 102 may then receive the second credit redemption notification from the e-commerce web services 140 in response to the request by the remote server 102. The second credit redemption notification from the e-commerce web services 140 may include event admission data. In particular, the second credit redemption notification from the e-commerce web service 140 may include purchase data related to purchase of the event admission at the kiosk. In one embodiment, the e-commerce web services 140 may obtain the event admission data from the event admission system. In another embodiment, the e-commerce web services 140 may have a database storing the event admission data. In any event, the event purchase data may include data such as, for example, purchase cost of the event admission, time of credit redemption, location of credit redemption, or any other similar purchase data. The credit manager 114A of the remote server 102 can update and/or reduce the second user's credit using the event admission data and/or purchase data in the second credit redemption notification from the e-commerce web services 140. For example, using the purchase cost of the event admission, the credit manager 114A of the remote server 102 can update and/or reduce the second user's credit by an amount corresponding to the purchase cost of the event admission.

Accordingly, from the foregoing it should be understood that the first credit redemption notification may include notification of at least one of: a first notification of time of credit redemption and a first notification of location of credit redemption. The credit manager 114A of the remote server 102 may request a second credit redemption notification from the e-commerce web services 140. The credit manager 114A of the remote server 102 may receive the second credit redemption notification from the e-commerce web services 140 in response to the request by credit manager 114A of the remote server 102. The second credit redemption notification may include at least one of: a second notification of time of credit redemption and a second notification of location of credit redemption.

The second credit redemption notification from the e-commerce web services 140 may also include additional data related to or associated with numerous purchases using the first user's credit code, in addition to the second user's authorized use of the first user's credit code for purchase of the event admission. For example, e-commerce web services 140 (e.g. gift-card service providers such as FIRST DATA®, COMDATA®, or other similar providers) may broadly report numerous purchases using the first user's credit code, in addition to the second user's authorized use of the first user's credit code for purchase of the event admission. The credit manager 114A of the remote server 102 may compare and/or correlate data of the of the first credit redemption notification with data of the second credit redemption notification, so as to identify and/or isolate data in the second credit redemption notification that is related to the second user's purchase and/or acquiring of the event admission.

In particular, the credit manager 114A of the remote server 102 may compare and/or correlate at least one of: the first notification of time of credit redemption with the second notification of time of credit redemption and the first notification of location of credit redemption with the second notification of location of credit redemption. The credit manager 114A of the remote server 102 may isolate and/or identify data in the second credit redemption notification that is related to the second user's purchase and/or acquiring of the event admission, based on correlation of at least one of: the first notification of time of credit redemption with the second notification of time of credit redemption, and the first notification of location of credit redemption with the second notification of location of credit redemption.

Using data in the second credit redemption notification that the credit manager 114A of the remote server 102 isolates and/or identifies as being related to the second user's purchase and/or acquiring of the event admission, the credit manager 114A of the remote server 102 can update and/or reduce the second user's credit. For example, when the credit manager 114A of the remote server 102 isolates and/or identifies the purchase cost of the event admission, the credit manager 114A of the remote server 102 can update and/or reduce the second user's credit by an amount corresponding to the purchase cost of the event admission. As another example, when the credit manager 114A of the remote server isolates and/or identifies descriptive information of the event admission, the credit manager 114A of the remote server 102 can notify first user of descriptive information of the event admission.

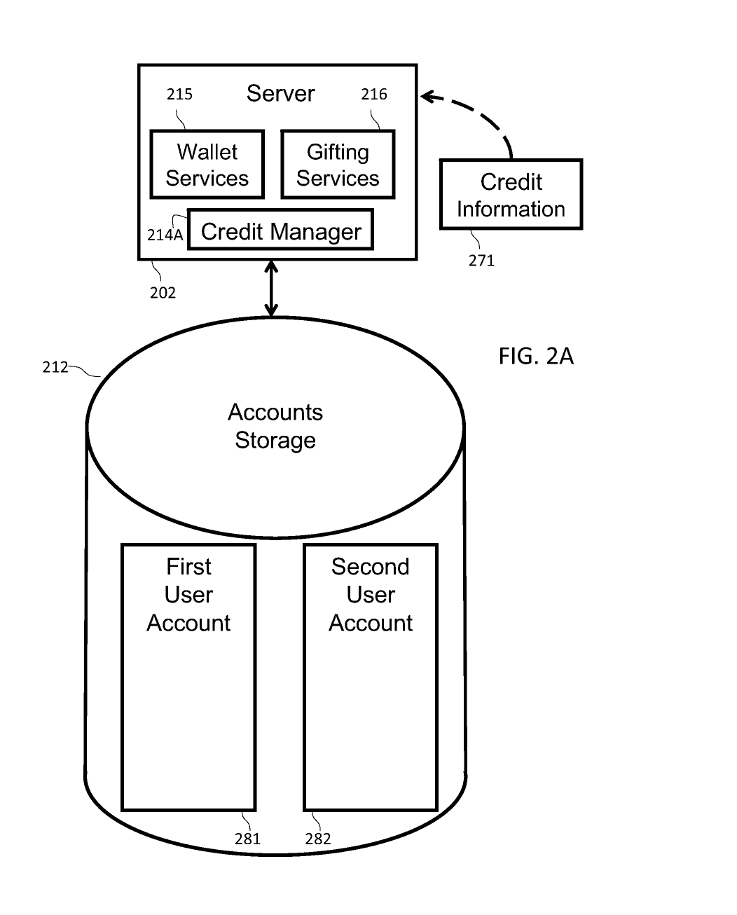

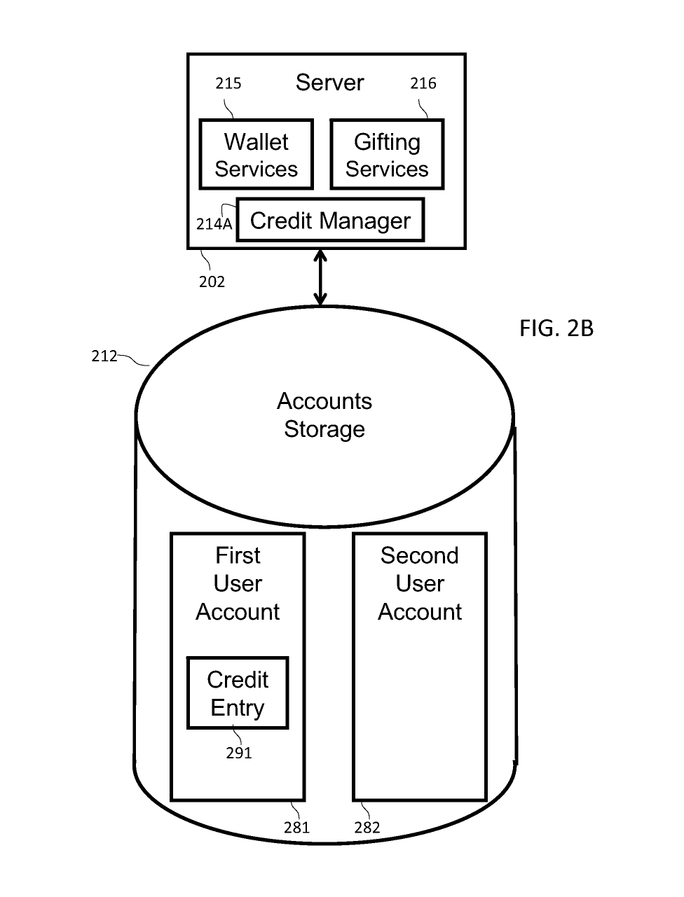

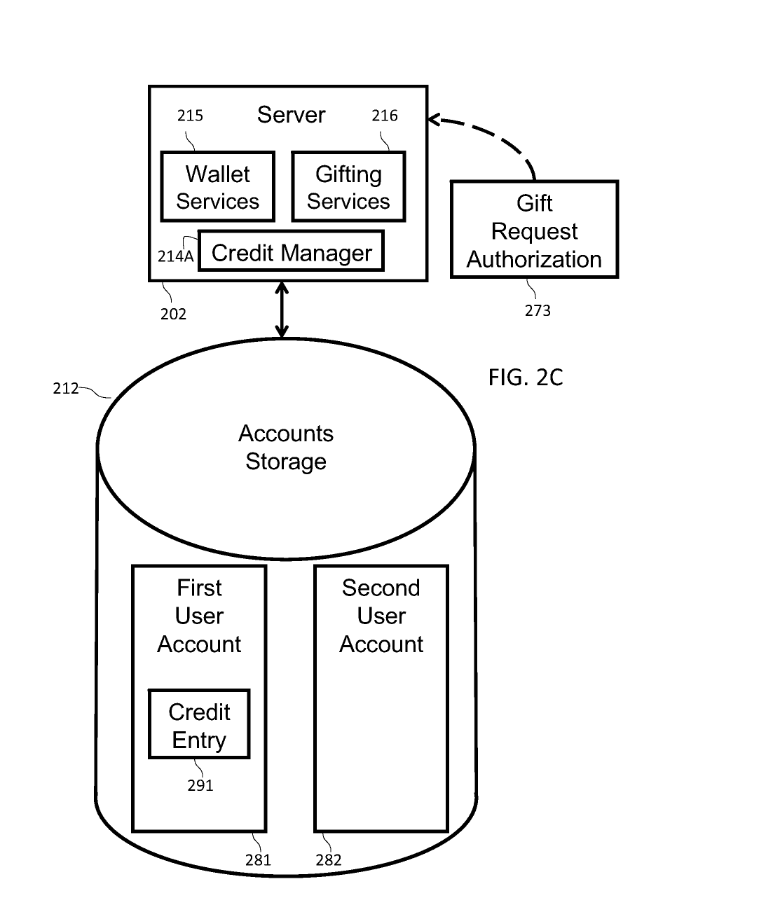

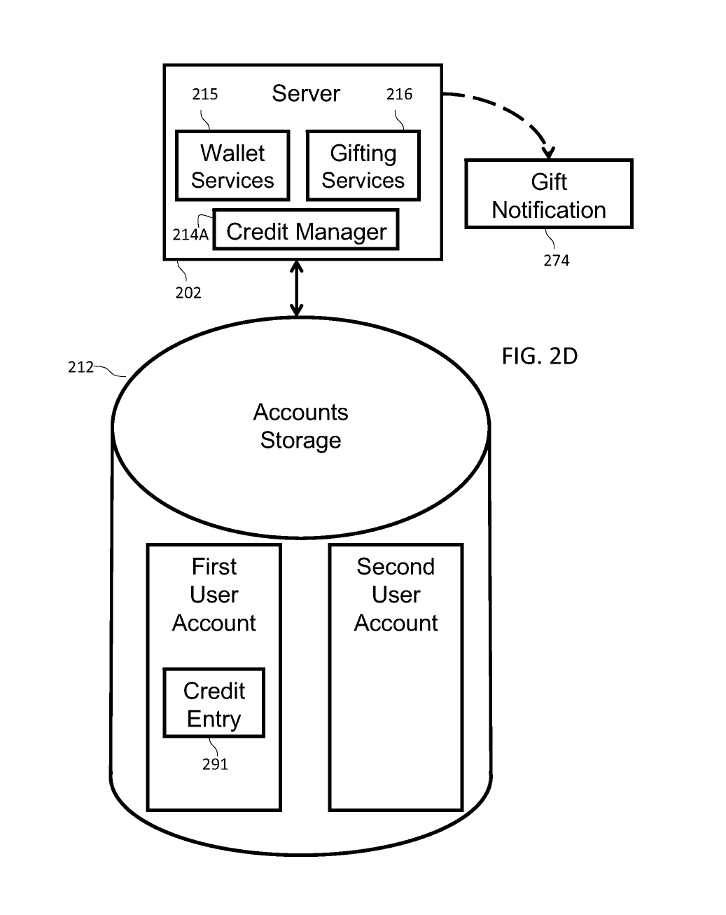

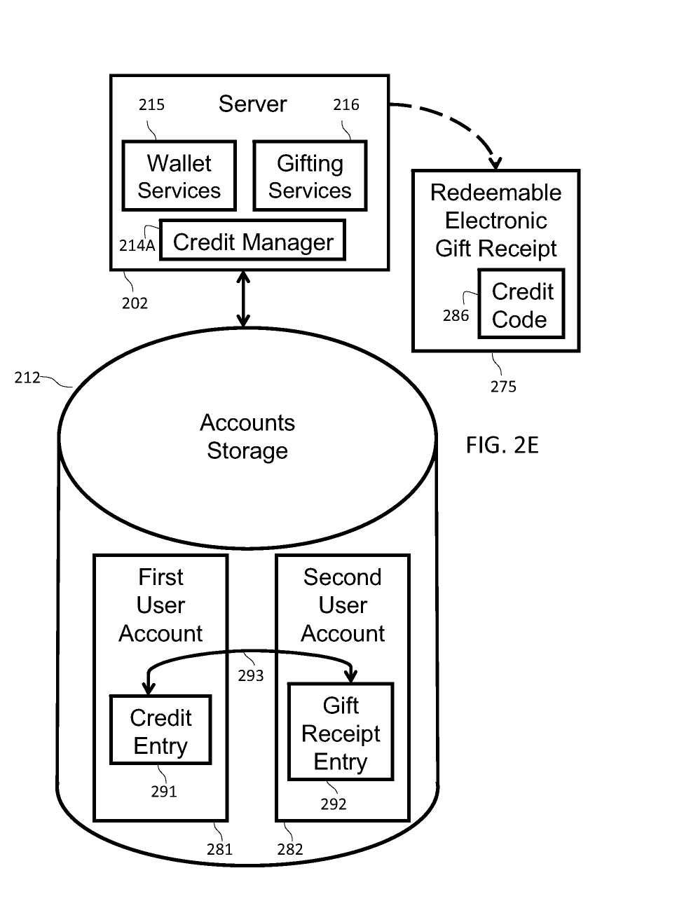

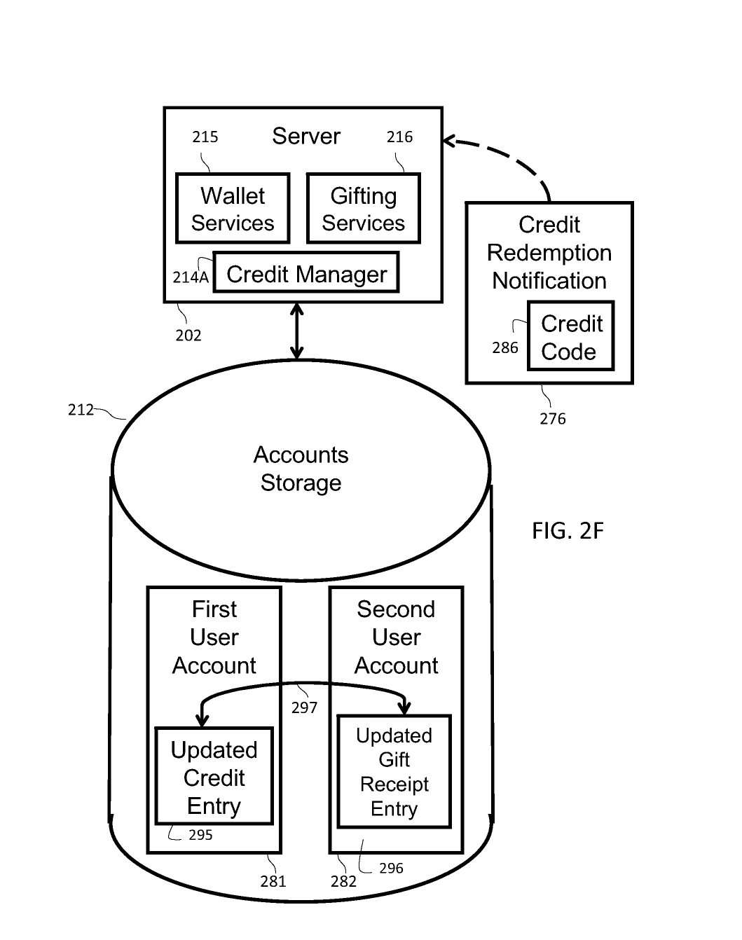

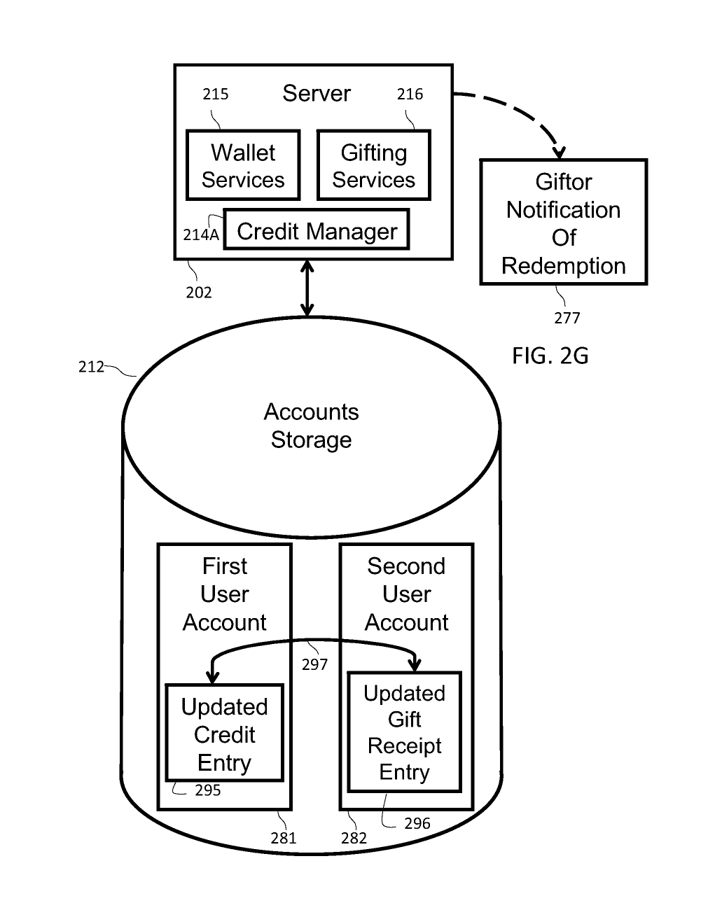

FIGS. 2A-2G are simplified detailed block diagrams illustrating operation of the gifting system 100 shown in FIG. 1. In accordance with previous discussions of the gifting system, FIGS. 2A-2G illustrate in greater detail operation of remote server 202 to coordinate obtaining, virtualizing, storing, and/or accessing items representative of credit, value and/or event admission using wallet services 215.

As shown in FIGS. 2A-2G, the accounts storage 212 may have a first user account 281 to be accessed via the data network by the first user, for example, by using the first client device. Similarly the accounts storage 212 may further include a second user account 282 to be accessed via the data network by the second user, for example, by using the second client device.

Referring now to FIG. 2A, the remote server 202 can be configured to coordinate obtaining and virtualizing of items representative of credit, value and/or event admission using wallet services 215. For example, using the wallet services 215, the remote server 202 may receive credit information 271 (e.g., gift card credit information, music card information, coupon information, transportation ticket information, entertainment ticket information, and the like) of a first user via the data network from the first client device. The credit information may include a unique credit code. For example, the credit code may be credit information associated with a gift card of the first user, or more generally, may be credit information associated with other items representative of credit, value and/or event admission such as coupons or entertainment or transportation event tickets of the first user. Referring now to FIG. 2B, the credit information of the first user, and in particular, credit codes of the first user, may be stored as credit entries 291 in the first user account 281 of the accounts storage 212. The wallet services 215 may control access to the credit entries 291 by authenticating and/or validating the user requesting access to the credit entries 291. The wallet services 215 may authenticate and/or validate the user by comparing credentials such as passwords, user names, and the like. For example, the wallet services 215 of the remote server 202 may validate access to the first user account 281 of the remote server 202 in response to receiving an account access validation request via the data network from the first user, using for example, the first client device.

Using the gifting services 216, the remote server 202 may coordinate sharing and/or gifting of items representative of credit, value and/or event admission. For example, the first user may be a giftor and the second user may be a giftee. As illustrated in FIG. 2C, using the gifting services 216, the first user may submit a gift request authorization 273 to the remote server 202 to share at least a portion of an item (e.g., a gift card, coupon, transportation ticket, entertainment ticket, or the like) with the second user. More particularly, the gifting services 216 of the remote server 202 may receive the gift request authorization 273 via the data network 106 from the first user of the first client device.

The gift request authorization 273 may include credit authorization data identifying and/or limiting the gift intended by the first user/giftor. For example, the gift request authorization 273 submitted by the first user may include credit authorization data to limit use of the gift credit for the second user/giftee. In other words, the credit authorization data may limit use of the gift credit by the second user to one or more of a particular price, price range, item, item type, event, event type, event admission, event admission type, or any other criteria. For example, the gift request authorization submitted by the first user may include credit authorization data that limits gift credit for the second user by identifying a particular item type that can be acquired by the second user. In another example, the gift request authorization submitted by the first user may include credit authorization data that limits gift credit for the second user by a monetary gift amount that is less than the known value of the first user's gift card. Further, in addition to the forgoing partial limitations, the credit authorization data may be updated to wholly limit and/or revoke the gift. The gift request authorization 273 may be updated and may be revocable by the first user of the first client device.

As illustrated in FIG. 2D the remote sever 202 may transmit a gift notification 274 from the remote server 202 to the second client device. Alternatively or additionally or inclusively as part of the gift notification 274, the remote sever 202 may transmit from the remote server 202 to the second client device, one or more associated notifications 274, which may comprise update information or other information associated with one or more gift cards and/or one or more credit codes. For example, when the first user/giftor shares a travel ticket with the second user/giftee, such as a ticket for an airline flight, the remote sever 202 may transmit from the remote server 202 to the second client device one or more associated notifications 274. This may comprise one or more live updates on the status of the airline flight, (or one or more activatable network links and/or credentials for accessing one or more live updates), which may be available through the ticket. The foregoing may be made available to the second user/giftee, just as it may be made available to the first user/giftor. The gift notification 274 and/or one or more associated notifications may be a push notification such that it is pushed to the second client device. The transmission of the gift notification 274 and/or one or more associated notifications may be in response to receipt of the gift request authorization from the first user/giftor. The gift notification 274 may identify the giftor. The gift notification may also identify the item, item type, event, event type, event admission, event admission type, particular physical redeemable gift, any other credit authorization data, or any other information necessary to inform the giftee of what can be obtained using the gift credits.

Referring now to FIG. 2E, to provide for such gifting, the gifting services 216 of the remote server 202 may electronically provide a redeemable electronic gift receipt 275 to the second user. In one embodiment, the gifting services 216 of the remote server 202 may transmit the redeemable electronic gift receipt 275 via the data network to the second user, for example, using the second client device. The redeemable electronic gift receipt may include credit code 286. The credit code of the redeemable electronic gift receipt may be stored as a gift receipt entry 292 in the second user account 282 of the accounts storage 212.

Wallet services 215 may control access to the gift receipt entry 292 in the second user account 282 of the accounts storage 212 by authenticating and/or validating the user requesting access to the gift receipt entry 292. The wallet services 215 may authenticate and/or validate the user by comparing credentials such as passwords, user names, and the like. For example, the wallet services 215 of the remote server 202 may validate access to the second user account 282 of the remote server 202 in response to receiving an account access validation request via the data network from the second user, using for example, the second client device. Information about the redeemable electronic gift receipt 275 may be stored in the gift receipt entry 292 in the database. The gift card of the first user/giftor may be associated with the redeemable electronic gift receipt 275 of the second use by electronically linking 293 the credit entry 291 with the gift receipt entry 292.

As illustrated in FIG. 2F the credit manager 214A of the remote server 202 may receive a credit redemption notification 276. The credit manager 214A may be configured to manage credit used to acquire redeemable gifts based on credit redemption data, user account data, and credit authorization data.

As discussed previously, the credit redemption data may be data used to validate one or more credit redemption requests for redemption of redeemable electronic gift receipts. For example, a credit redemption notification 276 may include a credit redemption request for redemption of the redeemable electronic gift receipt. The credit redemption notification 276 may have a credit code 286 of the redeemable electronic gift receipt. The credit redemption notification may include a validation request for validating the credit code 286 of the redeemable electronic gift receipt.

The credit manager 214A of the remote server 202 may receive the credit redemption notification 276 (and more particularly may receive the credit redemption request, the credit code of the redeemable electronic gift receipt, and/or the validation request) via the data network from the second client device.

The credit manager 214A may use the credit redemption data to validate the credit redemption request for redemption of the redeemable electronic gift receipts. In particular, the credit manager 214A of the remote server 202 may use the credit redemption data to validate the credit code 286 of the redeemable electronic gift receipt in response to the validation request.

It should be understood that the credit manager 114A can validate the credit code using the credit redemption data. If the credit code is determined to be valid, the credit manager 214A can allocate the credit associated therewith to a credit amount for the second user/giftee. Subsequently, if the second user requests to purchase an item or event admission, the credit manager 214A can determine whether the one or more items to be purchased can be provided to the user at no cost or a reduced cost by the application of some or all of the credit amount associated with the second user/giftee. In such cases, the credit manager 214A can determine whether the item or event admission to be purchased is authorized for credit utilization based upon the credit authorization data. When the credit authorization data indicates that the item or event admission is available for credit utilization, then the purchase cost for the item or event admission can be reduced or eliminated by the application of the gift credit or gift credit amounts associated with the second user/giftee.

For example, the first user may have a $20 dollar Starbucks® gift card, and the first user may want to share a portion of the gift card with the second user, namely gifting one Starbucks® drink to the second user. The first user may not know what drink the second user may order, but the first user may want to provide gift credit to the second user to purchase one beverage of the second users own choosing. By gifting an item type of “one beverage” instead of $5, the first user may avoid over gifting to the second user a monetary amount in excess of the one beverage to be chosen by the second user. Furthermore, by gifting the item type of “one beverage” instead of $5, the second user may avoid being strictly limited by price.

In the foregoing, the item type of “one beverage” may be designated by the first user in the credit authorization data. The credit manager 214A of the remote server 202 may consult the item type of “one beverage” as credit authorization data. For example, when the credit authorization data indicates that the particular item, such as the particular drink chosen by the second user, sufficiently matches the item type of “one beverage” in the credit authorization, the credit manager 214A of the remote server 202 may determine that the particular drink chosen by the second user is available for credit utilization. In such case, the purchase cost for the particular item may be reduced or eliminated by the application of the gift credit.

Subsequent to the purchase of the item or event admission, the credit manager 214A of the remote server 202 can update the second user's credit by an amount corresponding to the purchase cost of the item or event admission. For example, as shown in FIG. 2F, the credit manager 214A can record and update the second user's credit in updated gift receipt entry 296 in the second user account 282. The update of the user's credit may be to decrease or eliminate the second user's credit based upon the credit authorization, purchase cost, and any other criteria.

Similarly, using the purchase cost of the item or event admission, the credit manager 214A of the remote server 202 can update and/or reduce the first user's credit by an amount corresponding to the purchase cost of the item or event admission for the second user. For example, as shown in FIG. 2F, the credit manager 214A can record the update and/or reduction of the first user's credit in updated credit entry 295 in the first user account 281. The gift card of the first user/giftor may be associated with the redeemable electronic gift receipt 275 of the by electronically linking 297 the updated credit entry 295 with the updated gift receipt entry 296 in the database.

Referring now to FIG. 2G, the gifting services 216 may transmit a giftor notification of redemption 277 to notify the first user/giftor when the second user/giftee redeems the redeemable electronic gift receipt. The notification 277 may include descriptive information such as of date of purchase, time, location of where the second user/giftee redeemed the redeemable electronic gift receipt, cost of the item or event admission acquired by the second user/giftee, and any other descriptive information.

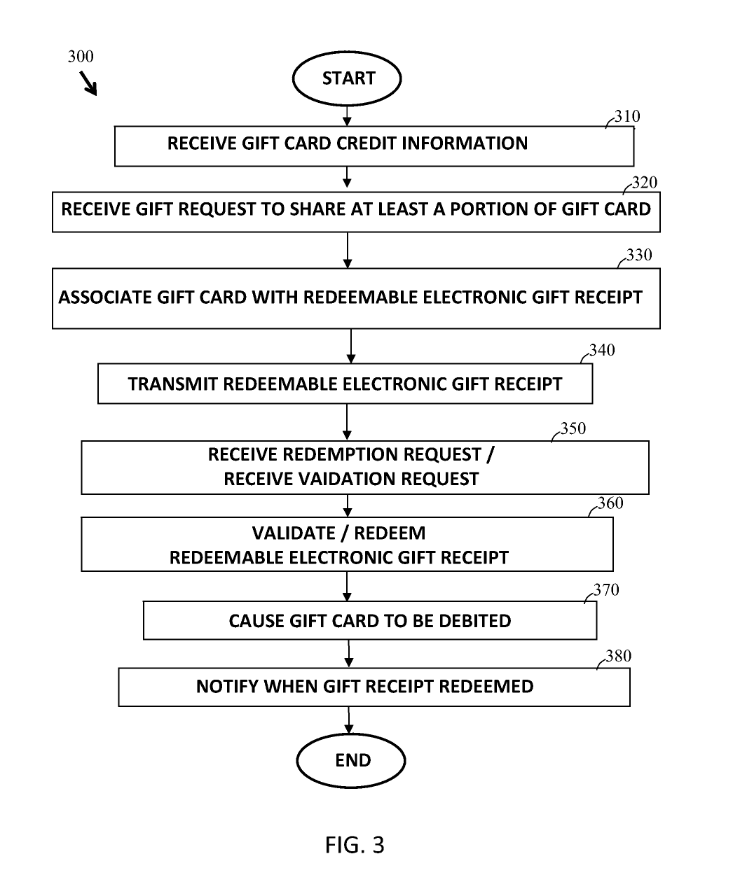

FIG. 3 is an exemplary flow diagram of a process 300 for sharing at least a portion of a gift card according to one embodiment of the invention. The process 300 may, for example, be performed by a network-based server, such as the remote server 102, 202 illustrated in FIG. 1 and FIGS. 2A-2G. Initially, the remote server may receive gift card credit information 310 from a first user with a gift card having a known value. The process 300 may continue, as the remote server may receive a gift request from the first user to share at least a portion of the gift card 320 with a second user. The gift request may include credit authorization data to identify, for example, a particular physical redeemable gift that may be acquired by the second user or a monetary gift amount that may be less than the known value.

The remote sever may associate the gift card with a redeemable electronic gift receipt 330. In one embodiment, a credit entry may be electronically linked with a gift receipt entry in a database, such as accounts storage 112, 212 illustrated in FIGS. 1-2A-G. The remote server may store gift card credit information in a credit entry of the database. The credit entry may be associated with the gift card and any redeemable electronic gift receipt.

The remote server may then transmit a redeemable electronic gift receipt to the second user 340. The redeemable electronic gift receipt may include any information or data that informs the second user of what the second user may use the gift credits for. For example, the redeemable electronic gift receipt may enable or allow the second user to acquire a particular redeemable gift, such as a drink. The remote server may then receive a redemption request for redemption of the redeemable electronic gift receipt 350. In another embodiment, the remote server may receive a validation request for validation of a credit code of the redeemable electronic gift receipt 350. The credit code of the redeemable electronic gift receipt may be validated 360 in response to the validation request. In another embodiment, the redeemable electronic gift receipt may be redeemed in response to the redemption request, so as to enable the second user to acquire the particular redeemable gift. In doing so, the remote server may base the validation and/or redemption of the redeemable electronic gift receipt based upon credit redemption data, user account data and credit authorization data.

If the second user requests to purchase a particular physical redeemable gift, the remote sever can determine whether the physical redeemable gift can be provided to the user at no cost or a reduced cost by the application of some or all of the credit amount associated with the second user/giftee. In such cases, the remote server can determine whether the particular physical redeemable gift to be purchased is authorized for credit utilization based upon the credit authorization data. When the credit authorization data indicates that the particular physical redeemable gift is available for credit utilization, then the purchase cost for the particular physical redeemable gift can be reduced or eliminated by the application of the gift credit associated with the second user/giftee.

For example, the first user may have a $20 dollar BestBuy® gift card, and the first user may want to share a portion of the gift card with a second user to buy a compact disc (CD) album. Although the first user may not know what album the second user would like to buy, the first user still wants to provide gift credit to the second user to purchase the album of the second user's own choosing. By gifting an item type of “one CD” instead of $10, the first user may avoid over gifting to the second user a monetary amount in excess of the one CD chosen by the second user. Furthermore, by gifting the item type of “one CD” instead of $10, the second user may avoid being strictly limited by price.

The item type of “one CD” can be designated by the first user as credit authorization data. The remote server can consult the item type of “one CD” as credit authorization data. For example, when the credit authorization data indicates that the particular physical redeemable gift, such as the particular CD chosen by the second user, sufficiently matches the item type of “one CD” in the credit authorization, the remote server may determine that the particular drink chosen by the second user is available for credit utilization. In such case, the purchase cost for the CD may be reduced or eliminated by the application of the gift credit.

The gift card may be debited 370 by an amount based on, for example, a purchase cost of the particular physical redeemable gift. In other words, a credit amount associated with the gift card may be debited by an amount based on, for example, the purchase cost. The remote server may then notify the first user when the second user redeems the redeemable electronic gift receipt 380. Once the first user has been notified 380, the process 300 may end.

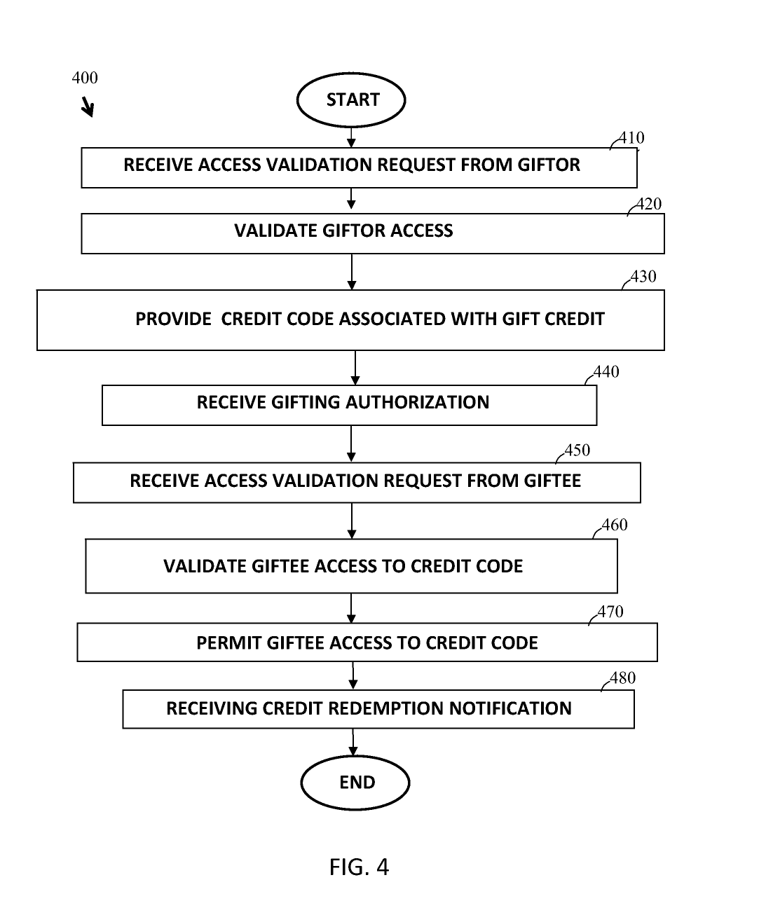

FIG. 4 is a flow diagram of an example process 400 for acquiring an item or an admission to an event using a gift credit according to one embodiment of the invention. The process 400 is, for example, performed by a network-based server, such as the remote server 102, 202 illustrated in FIG. 1 and FIGS. 2A-2G. Initially, the remote server may receive an account access validation request from a giftor 410. The giftor may use, for example, a first electronic device 120 as illustrated in FIG. 1. The remote server may validate the giftor's access 420 to the first user account of the remote server by any known validation methods in response to the giftor's account access validation request. For example, the first user may need to input a password, user name, and/or any other identifying data to be authenticated or validated.

A credit code associated with the gift credit may be provided at 430. In another embodiment, the credit code may also be associated with the giftor. The remote server may receive, via a computer network, a gifting authorization from the giftor 440 using a first electronic device to allow access to the credit code by a giftee.

The process 400 may continue as the remote server may receive, via the computer network, an access validation request from or for the giftee 450 using a second electronic device. The remote server may then validate the giftee's access to the credit code 460 in response to the validation request.

If the giftee's access to the credit code is validated, the giftee may be permitted to access the credit code at 470. The remote server may thereafter receive a credit redemption notification 480 indicating consumption of a gift credit associated with the credit code to reduce or eliminate a purchase cost of the item or admission to an event acquired or purchased by the giftee. In one embodiment, the event may be an entertainment event, and the gift credit may be an entertainment admission credit. In another embodiment, the event may be a transportation event, and the gift credit may be a transportation admission credit.

In one embodiment, the remote server may include an online media store, the item may be a media item, and the gift credit may be a media item credit. In another embodiment, the gift credit may be associated with a discount coupon. Once the credit redemption notification is received 480, the process 400 may end.

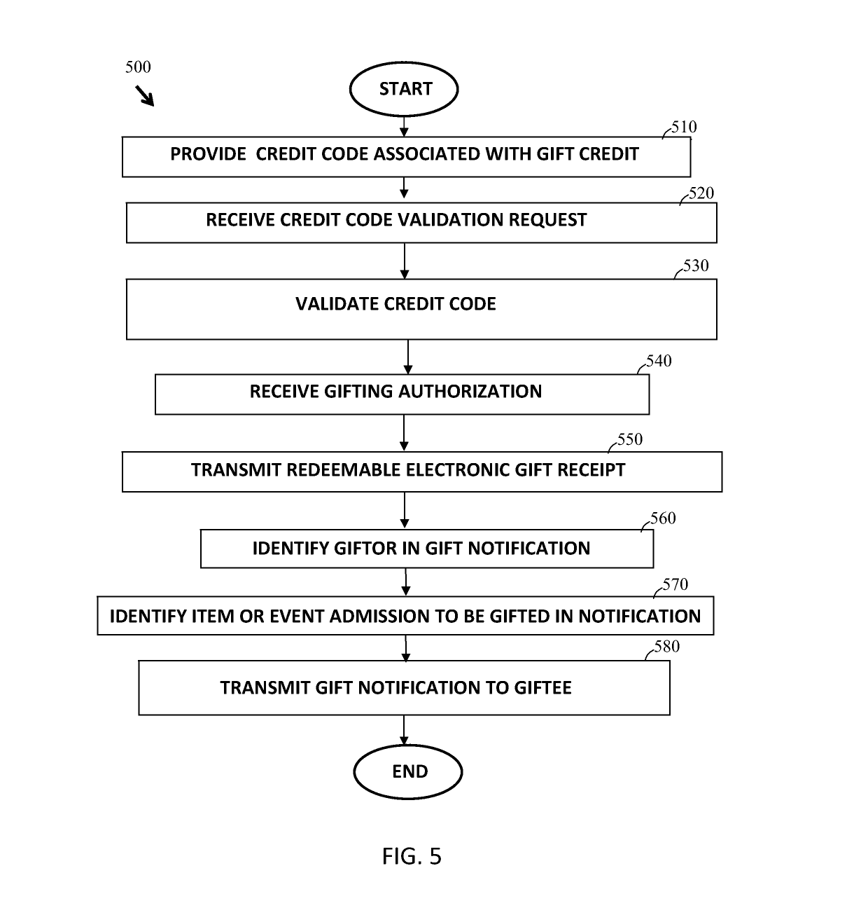

FIG. 5 is a flow diagram of another exemplary process 500 for acquiring an item or an admission to an event using a gift credit according to another embodiment of the invention. The process 500 may be, for example, performed by a network-based server, such as the remote server 102, 202 illustrated in FIG. 1 and FIGS. 2A-2G. Initially, a credit code of a giftor may be provided at the remote server 510. The gift credit may be associated with the credit code. The remote server may then receive a credit code validation request 520. In response to the credit code validation request, the remote server may validate the credit code 530.

The process 500 may continue as the remote server may receive, via a computer network, a gifting authorization from the giftor. The giftor may transmit the gifting authorization using, for example, a first electronic device to allow access to the credit code by a giftee. The gifting authorization from the giftor may include credit authorization data identify an item type for the item that may be acquired by the giftee. The remote server may then transmit a redeemable electronic gift receipt to the giftee 550. The remote server may identify the giftor in a gift notification 560 as well as an item or event admission to be gifted 570.

A gift notification may be transmitted to the giftee from the remote server 580. Alternatively or additionally or inclusively as part of the gift notification, one or more associated notifications, which may comprise update information or other information associated with one or more gift cards and/or one or more credit codes, may be transmitted to the giftee from the remote server 580. For example, when the giftor shares a travel ticket with the giftee, such as a ticket for an airline flight, the remote sever may transmit from the remote server to the giftee one or more associated notifications. This may comprise one or more live updates on the status of the airline flight, (or one or more activatable network links and/or credentials for accessing one or more live updates), which may be available through the ticket. The foregoing may be made available to the giftee just as it may be made available to the giftor. The gift notification and/or one more associated notifications may be transmitted via the computer network to, for example, a second electronic device associated with the giftee. The gift notification and/or one or more associated notifications may be a push notification. The remote server may transmit the gift notification and/or one or more associated notifications in response to receiving the gifting authorization from the giftor. Once the gift notification and/or one or more associated notifications is transmitted to the giftee 580, the process 500 may end.

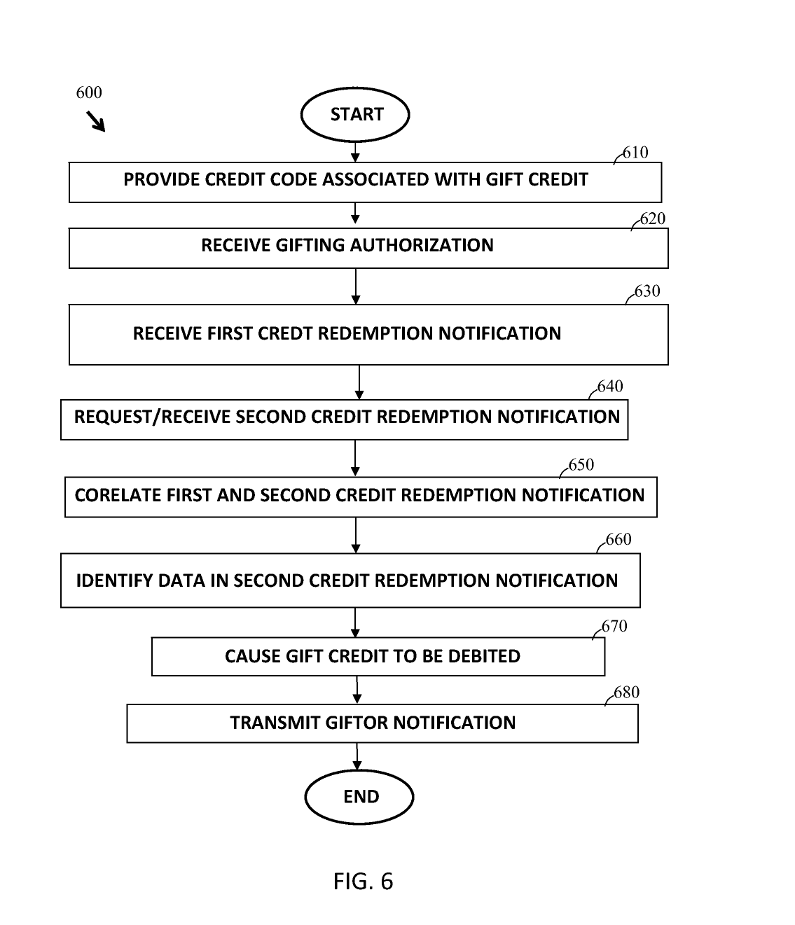

FIG. 6 is a flow diagram of another exemplary process 600 for acquiring an item or an admission to an event using a gift credit according to another embodiment of the invention. The process 600 may be, for example, performed by a network-based server, such as the remote server 102, 202 illustrated in FIG. 1 and FIGS. 2A-2G. Initially, a credit code may be associated with a giftor. The credit code may then be associated with gift credit 610. The remote server may then receive, via a computer network, a gifting authorization from the giftor 620. The gifting authorization may be transmitted using, for example, a first electronic device to allow access to the credit code by a giftee.

The remote server may receive a first credit redemption notification 630 indicating consumption of the gift credit associated with the credit code to reduce or eliminate a purchase cost of an item or the admission to an event acquired by the giftee. The first credit redemption notification may be, for example, received via the computer network from the giftee using the second electronic device. The first credit redemption notification may include notification of at least one of: a first notification of time of credit redemption and a first notification of location of credit redemption.

The remote server may then request, and may receive in response to such request, a second credit redemption notification from an e-commerce web service 640. The second credit redemption notification may include at least one of: a second notification of time of credit redemption and a second notification of location of credit redemption.

The remote server may correlate the first and second credit redemption notifications 650. The remote server may correlate at least one of: the first notification of time of credit redemption with the second notification of time of credit redemption, and the first notification of location of credit redemption with the second notification of location of credit redemption. Data in the second credit redemption notification that is related to the giftee acquiring the item or the admission to the event may be identified 660. The identification may be based on correlation of at least one of: the first notification of time of credit redemption with the second notification of time of credit redemption, and the first notification of location of credit redemption with the second notification of location of credit redemption.

When the remote server identifies data in the second credit redemption notification, the remote server may identify purchase cost of the item or the admission to the event purchased or acquired by the giftee. When the remote server identifies data in the second credit redemption notification, the remote server may identify descriptive information of the item or the admission to the event purchased or acquired.

The gift credit may be debited by an amount corresponding to the purchase cost of the item or the admission to the event purchased or acquired by the giftee. The remote server may then transmit a giftor notification to the giftor 680. The giftor notification may inform the giftor that the gift credit was utilized by the giftee and may include descriptive information of the item or the admission to the event purchased or acquired by the giftee. Other identifying information may also be included with the giftor notification such as time, date of purchase, and the like. Once the giftor notification has been transmitted 680, the process 600 may end.

One or more client devices and/or one or more servers may be configured in various ways to share at least a portion of a gift card and/or to allow access to a credit code. One or more client devices and/or one or more servers may be configured to use one or more gift requests and/or one or more gifting authorizations. Any and/or all of the foregoing may be configured dynamically and/or may be configured automatically. Any and/or all of the foregoing may be configured for a single instance and/or for multiple instances and/or for recurring instances. For example, one or more client devices and/or one more servers may be configured to provide for a first user (e.g. a parent) purchasing one or more bus tickets for a second user (e.g. a child) every month for a plurality of months; and/or may be configured for sharing the one or more bus tickets to the second user every month for the plurality of months.

One or more client devices and/or one or more servers may be configured to provide for acquiring an item, and/or an admission to an event and/or location, and/or access to a resource, using a gift credit. A credit code of a giftor may comprise a credential and may be associated with the gift credit. One or more client devices and/or one or more servers may be configured to provide for a gifting authorization from the giftor, and to allow access to the credit code and/or credential by a giftee. Such access to the credit code and/or credential may enable the giftee to acquire the item and/or the admission to the event and/or location, and/or access to the resource. For example, the credit code of the giftor may be an identification badge credential. This may enable the giftee to acquire admission to a location, such as a building.

One or more client devices and/or one or more servers may be configured to provide for partially limiting and/or wholly limiting and/or revoking the gift. As discussed previously herein, credit authorization data may be updated to wholly limit and/or revoke the gift. The gift request authorization discussed previously herein may be updated and may be revocable by the giftor, for example, using the first client device. Accordingly, in the previous example wherein the credit code of the giftor may be an identification badge credential, such identification badge credential may be limited and/or revoked. This may disable and/or limit the giftee from acquiring admission to a particular location, such as a particular building.

The invention can be implemented by software, hardware or a combination of hardware and software. The invention can also be embodied as computer readable code on a tangible computer readable medium. The tangible computer readable medium is any data storage device that can store data which can thereafter be read by a computer system. Examples of the computer readable medium include read-only memory, random-access memory, CD-ROMs, DVDs, magnetic tape and optical data storage devices.

The advantages of the invention are numerous. Different aspects, embodiments or implementations may yield one or more of the following advantages. One advantage of the invention is that gift cards may be virtualized for ease of management. Another advantage of the invention is that gift credit may be shared.

The various aspects, embodiments, implementations or features of the invention can be used separately or in any combination.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer implemented method for sharing at least a portion of a gift card having a known value, comprising:
receiving gift card credit information from a first user;
receiving a gift request from the first user to share at least a portion of the gift card with a second user, the gift request identifying a particular physical redeemable gift that can be acquired by the second user or a monetary gift amount that is less than the known value; and
electronically providing a redeemable electronic gift receipt to the second user, the redeemable electronic gift receipt being representative of the gift request and enabling the second user to physically acquire the particular physical redeemable gift.

2. A method as recited in claim 1 further comprising:
storing the gift card credit information in a credit entry in a database, wherein the gift card credit information is associated with the gift card;
storing gift receipt information in a gift receipt entry in the database, wherein the gift receipt information is associated with the redeemable electronic gift receipt; and
associating the gift card with the redeemable electronic gift receipt by electronically linking the credit entry with the gift receipt entry in the database.

3. A method as recited in claim 1 further comprising:
receiving a redemption request for redemption of the redeemable electronic gift receipt; and
redeeming the redeemable electronic gift receipt in response to the redemption request, so as to enable the second user to physically acquire the particular physical redeemable gift.

4. A method as recited in claim 1 further comprising causing the gift card to be debited by an amount based on a purchase price for the particular physical redeemable gift.

5. A method as recited in claim 1 further comprising:
receiving a validation request for validation of a credit code of the redeemable electronic gift receipt; and
validating the credit code of the redeemable electronic gift receipt in response to the validation request.

6. A method as recited in claim 1 further comprising notifying the first user when the second user redeems the redeemable electronic gift receipt.

7. A computer implemented gifting method for acquiring an item or an admission to an event using a gift credit comprising:
providing, at a remote server, a credit code of a giftor, the gift credit being associated with the credit code;
receiving at the remote server a gifting authorization from a first electronic device to allow access to the credit code by a giftee, the gifting authorization including a validation request;
validating the validation request;
permitting access to the credit code by the giftee if the validation request is valid; and
thereafter receiving credit redemption notification at the remote server indicating consumption of the gift credit associated with the credit code to reduce or eliminate a purchase cost of the item or the admission to the event acquired by the giftee.

8. A method as recited in claim 7 further comprising validating access to a first user account in response to receiving an account access validation request from the first electronic device.

9. A method as recited in claim 8 further comprising storing the credit code associated with the first user in the first user account.

10. The method as recited in claim 7 wherein:
the event is an entertainment event; and
the gift credit is an entertainment admission credit.

11. The method as recited in claim 7 wherein:
the event is a transportation event; and
the gift credit is a transportation admission credit.

12. The method as recited in claim 7 wherein:
the remote server comprises an online media store;
the item is a media item; and
the gift credit is a media item credit.

13. The method as recited in claim 7 wherein the gift credit is associated with a discount coupon.

14. A computer implemented gifting method for acquiring an item or an admission to an event or location, or access to a resource, using a gift credit, the method comprising:
providing, at a remote server, a credit code of a giftor, wherein the gift credit is associated with the credit code;
receiving, at the remote server, a gifting authorization from a first electronic device to allow access to the credit code by a giftee; and
transmitting a gift notification from the remote server to a second electronic device.

15. The method as recited in claim 14 wherein the transmitting includes pushing the gift notification to the second electronic device.

16. A method as recited in claim 14 wherein the transmitting the gift notification is in response to the receiving the gifting authorization from the giftor.

17. The method as recited in claim 14 wherein the gift notification identifies the giftor.

18. The method as recited in claim 14 wherein the gift notification identifies the event or the location or the resource.

19. The method as recited in claim 14 wherein:
the gifting authorization from the giftor identifies an item type for the item to be acquired by the giftee; and
the gift notification identifies the item type for the item to be acquired by the giftee.

20. A computer implemented gifting method for acquiring an item or an admission to an event using a gift credit, the method comprising:
providing at a remote server a credit code of a giftor, wherein the gift credit is associated with the credit code;
receiving at the remote server via a computer network a gifting authorization from the giftor using a first electronic device to allow access to the credit code by a giftee; and
thereafter receiving credit redemption notification at the remote server indicating consumption of the gift credit associated with the credit code to reduce or eliminate a purchase cost of the item or the admission to the event acquired by the giftee.

21. The method as recited in claim 20 wherein the receiving credit redemption notification comprises receiving credit redemption notification from the second electronic device.

22. The method as recited in claim 20 wherein receiving credit redemption notification from the second electronic device comprises receiving notification of a time of credit redemption.

23. The method as recited in claim 20 wherein receiving credit redemption notification from the second electronic device comprises receiving notification of a location of credit redemption.

24. The method as recited in claim 20 wherein the receiving credit redemption notification comprises receiving the credit redemption notification from an e-commerce web service.

25. The method as recited in claim 20 wherein:
the receiving credit redemption notification comprises receiving a first credit redemption notification from the second electronic device; and
the method further comprises:
requesting, by the remote server, a second credit redemption notification from an e-commerce web service in response to receiving the first credit redemption notification from the second electronic device; and
receiving, at the remote server, the second credit redemption notification from the e-commerce web service in response to the request by the remote server.

26. The method as recited in claim 20 wherein:
the receiving credit redemption notification comprises receiving a first credit redemption notification from the second electronic device, wherein the first credit redemption notification includes notification of at least one of: a first notification of time of credit redemption and a first notification of location of credit redemption; and
the method further comprises:
requesting, by the remoter server, a second credit redemption notification from an e-commerce web service;
receiving, at the remote server, the second credit redemption notification from the e-commerce web service in response to the request by the remote server, wherein the second credit redemption notification includes at least one of: a second notification of time of credit redemption and a second notification of location of credit redemption; and
correlating at least one of: the first notification of time of credit redemption with the second notification of time of credit redemption, and the first notification of location of credit redemption with the second notification of location of credit redemption.

27. The method as recited in claim 26 further comprising:
determining identifying data in the second credit redemption notification associated with the giftee based on at least one of: the first notification of time of credit redemption with the second notification of time of credit redemption, and the first notification of location of credit redemption with the second notification of location of credit redemption.

28. The method as recited in claim 27, further comprising:
identifying a purchase cost of the item or the admission to the event acquired by the giftee based on the determined identifying data; and
reducing the gift credit by an amount equal to or less than the purchase cost.

29. The method as recited in claim 27, further comprising:
determining descriptive information of the item or the admission to the event acquired by the giftee; and
transmitting a giftor notification to the first electronic device, the giftor notification including the determined descriptive information.
